(19) United States
(12) Patent Application Publication
(10) Pub. No.: US 2025/0118166 A1
(43) Pub. Date: Apr. 10, 2025

(54) TOURNAMENT PLAY FOR LIVE GAMING EVENTS

(71) Applicant: Interblock d.o.o., Menges (SI)

(72) Inventors: John Joseph Connelly, Las Vegas, NV (US); Tomaz Fink, Kamnik (SI); Jeffrey Kowalchuk, Las Vegas, NV (US)

(21) Appl. No.: 18/896,435

(22) Filed: Sep. 25, 2024

Related U.S. Application Data
(60) Provisional application No. 63/588,963, filed on Oct. 9, 2023.

(51) Int. Cl. G07F 17/32

(52) U.S. Cl. CPC G07F 17/3276; G07F 17/323; G07F 17/3269; G07F 17/3293

(57) ABSTRACT

The present disclosure relates to systems and methods for roulette gaming systems including an automated roulette wheel and a plurality of player stations having a display providing a gaming interface to wager on roulette gaming events at the automated roulette wheel. Embodiments may include a computing device to provide the gaming interface, set a betting window, receive at least one bet from a player station, determine a type of roulette ball (e.g., normal or multiplier) to be launched into the roulette wheel for the gaming event, a random set of symbols and a separate multiplier value for each symbol in the set of symbols. Payouts are based on the result of the roulette event, and when the result is a symbol in the set of symbols, the multiplier value associated with the symbol.

### CROSS REFERENCE TO RELATED APPLICATIONS

This application claims benefit under 35 U.S.C. § 119 (e) of Provisional U.S. Patent Application No. 63/588,963, filed Oct. 9, 2023, the contents of which is incorporated herein by reference in its entirety.

### TECHNICAL FIELD

The present disclosure relates generally, but not exclusively, to the field of gaming, particularly electronic table games.

### BACKGROUND INFORMATION

Casinos offer a variety of games to attract players. Such games may include live table games (e.g., roulette, craps, blackjack, etc.), virtual games, physical machines (e.g., slot-like machines and electronic table games), individual player machines, stadium-style group stations, and various gameplay combinations.

Traditional table games require a highly skilled dealer to manage gaming events. A dealer must supervise and manage bets from one or more players, shuffle and deal cards, operate devices (e.g., a card shoe, roulette wheel, etc.), determine payouts based on the outcome, and address any disputes or technical issues that arise.

As a result, the player to dealer ratio is typically 5:1 or 6:1 for many table games, including roulette, blackjack, baccarat, and craps. The player to dealer ratio can be a limiting factor for roulette tables and gaming locations that have a high demand and multiple players waiting to play. A live dealer also comes with the potential for human error and payout mistakes, such as where a losing bet is accidentally paid out or more is paid on a winning bet than should have been paid. Casinos and gaming locations operating roulette tables and live table games must therefore innovate to attract and retain players, maintain profitability, and improve player experience.

### SUMMARY

Embodiments are directed towards systems, methods, and devices for operating tournament play for live gaming events. Gaming events may include card games, such as baccarat and blackjack, and roulette games. Tournament gaming events include fully automated virtual tournaments to enable players to compete amongst each other rather than the house. A dealer console may communicate with a plurality of player device (e.g., player stations, mobile computing devices, laptops, tablets, etc.) to manage tournament features and gameplay. The dealer console may be configured to register players, start and end tournaments, define tournament characteristics, such as a number of rounds, type of play, chips, betting windows, and time limits. The dealer console may also manage one or more gaming interfaces on player devices to toggle between a tournament mode and a regular game mode.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is an example electronic blackjack gaming system in accordance with an embodiment.

FIG. 2 is an example gaming interface for a roulette tournament, in accordance with an embodiment.

FIG. 3 is an example gaming interface providing a live video feed during a tournament, in accordance with an embodiment.

FIG. 4 is an example gaming interface showing results during a tournament event, in accordance with an embodiment.

FIG. 5 is an example gaming interface during a tournament event, in accordance with an embodiment.

FIG. 6 are example banner displays for a tournament event, in accordance with an embodiment.

FIG. 7 are additional displays for a tournament event, in accordance with an embodiment.

FIG. 8 is an example arrangement of a live roulette gaming table and player stations, in accordance with an embodiment.

FIG. 9 is an example arena arrangement of a live roulette gaming table and player stations, in accordance with an embodiment.

FIG. 10 is an example arrangement of a live card gaming table and player stations, in accordance with an embodiment.

FIG. 11 is an illustration of an exemplary block diagram representing a general-purpose computer system in which aspects of the methods and systems disclosed herein or portions thereof may be incorporated.

### DETAILED DESCRIPTION OF EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and non-transitory computer readable storage media for managing and operating tournament play for live gaming events. Tournament events may connect live events at gaming tables to online, virtual gameplay. In various examples, card and roulette games, such as blackjack, baccarat, and roulette, may be played in a unique tournament gaming method, to enable players to compete against each other, rather than the house. Tournament events may be managed at a dealer console, and individual rounds and gaming events may be fully automated. As such, tournament events may provide multiple rounds of play (e.g., three, four, five or more rounds) within a predictable, consistent, and predetermined time (e.g., under five, six, seven, eight minutes).

The tournament interface may provide a unique look and feel to distinguish from a standard table game and betting layout. The tournament interface may be provided on any of a plurality of gaming devices, including but not limited to player stations, local and remote computing devices, desktops, laptops, tablets, or other interactive displays.

Players may join tournaments regardless of their location. Tournaments may have local players within a casino or gaming location, e.g., playing on a player station, or at a hybrid table, and remote players, e.g., playing on a smart phone or other computing device.

One or more dealer console may track and manage connecting devices to identify active players, and to help ensure a smooth gameplay experience. A dealer console may cause one or more player machines or player devices to switch from a standard game to a tournament event. The dealer console may manage one or more aspects of gaming interfaces, such as the tournament interface, to indicate that a tournament is or will be starting. The dealer console may also help manage connections with the player devices to the tournament event, resolve any issues, and provide a consistent gameplay experience to players regardless of connection type and location.

In the tournament events, players may compete with each other over a period of time (e.g., one hour, two hours, twenty-four hours, one week, or more) and generate a leaderboard. Gaming locations, such as casinos, may offer prizes, free games, or other rewards for players who win tournaments. Prizes and/or payouts may be provided, for example, for a round of tournament, for a set of rounds in a tournament, a daily prize (e.g., to the top player(s) on the leaderboard), or over another predetermined period of time. Some prize examples include a cash prize, a product, free play, and virtual player highlights and announcements over social media, email, and other virtual avenues.

In an example, a daily leader (e.g., a Daily Chip Leader) may be identified and rewarded a prize. In some examples, the daily leader may have their photo and chip count identified on one or more displays providing tournament information. The daily leader's photo and chip count may be provided on a tournament banner on a gaming interface, or on at least one display (e.g., a large LED wall) at a gaming location. One or more dealers, announcers, and entertainers at the gaming location may announce the daily leader's name and chip count throughout the day.

An example tournament gameplay flow may include a set number of rounds occurring in a set time window. In a live roulette tournament, there may be three rounds, with one spin in each round, and a time-limited betting clock (e.g., 25 seconds) for each round. In a single hand blackjack tournament, there may be three rounds, with one hand dealt in each round, also with a time-limited betting clock (e.g., 15 seconds). In either event, the entire tournament, from start to finish, may be under a certain time (e.g., 5, 6, 7, 8 minutes, etc.).

Tournament events are therefore fully configurable and customizable. A number of rounds, the betting window, time of play, chip requirements, and any of a plurality of tournament variables and characteristics may be customized to create a desired tournament gameplay and length of play. Tournaments may be scheduled or occur spontaneously, on the fly, at a dealer console. Any of a plurality of tournament variables may be defined and managed at a dealer console.

Accordingly, the various tournament events and gameplay discussed herein may provide significant gaming benefits to casinos and gaming locations. Tournament gameplay may drive visitation and participation at gaming locations, especially during peak periods. Tournaments are customizable, and invitational tournaments may be designed to invite certain players (e.g., VIP players) to play in certain tournaments and/or receive certain prizes for winning tournaments. Such techniques and invitational tournaments may improve customer loyalty to a gaming location.

Tournaments may also be implemented as an introductory tool, enabling new players to learn about and try ETGs. Tournaments may also be a method to introduce new games to any player. For example, free tournaments may attract players who otherwise would not be willing to spend money to try to learn how to play an unfamiliar game.

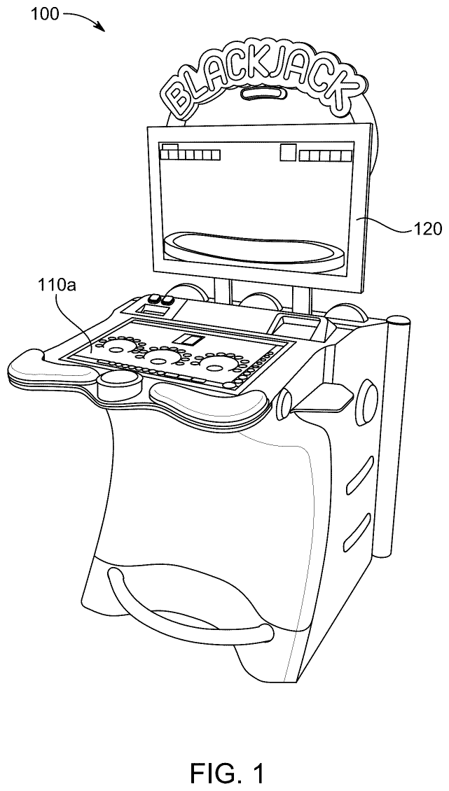

FIG. 1 illustrates an example blackjack gaming system 100 in accordance with embodiments discussed herein. Such gaming systems may be an individual play station, such as an electronic table game, providing blackjack and, optionally, other casino games, such as roulette and baccarat. The gaming system 100 may include a display 120 and player controls 110 through which bets and other blackjack gaming operations may be implemented. The display 120 may provide a graphical user interface, as discussed herein, that provides blackjack hands, betting options, payout information, event information, player history, player account information, and any of a plurality of gaming information. In some examples, the display 120 may be a touchscreen, on which users may select various gaming operations. The player controls may include one or more buttons to make selections provided on display 120.

Although FIG. 1 illustrates a single play station, one skilled in the art will recognize that blackjack gaming systems may include a singly play station or any number of play stations. For example, the live gaming system may include one play station, two play stations, ten play stations, and so on. In an embodiment, the gaming system 100 may not include any play stations. For example, live gaming system 100 may be servicing one or more remote clients or user devices not physically proximate to the gaming system 100. In an embodiment, the blackjack gaming system 100 may be servicing a combination of local play stations and remote play stations. And, while a blackjack gaming machine is illustrated, any type of electronic gaming machine may be utilized, including universal cabinets, providing other games, and gaming systems, such as slots, dice systems, e.g., for craps or sic bo, and card systems, e.g., for poker, blackjack, baccarat, pai gow poker, etc.

According to various embodiments, blackjack games are composed of a betting window associated with a game cycle. The game cycle may be a round of blackjack, and the betting window includes a bet open time and a bet close time. The bet open time represents a point in time in which the betting window transitions from a closed state to an open state. After the bet open time, the betting window is in the open state and a player is allowed to place one or more bets or wagers on the associated game cycle. In an embodiment, the player is allowed to place one or more side bets or wagers on at least one additional game of chance when the betting window is in the open state.

The bet close time represents a point in time in which the betting window transitions from an open state to a closed state. After the bet close time, the betting window is in the closed state and the player is no longer allowed to place bets or wagers on the associated game cycle. In an embodiment, the bet close time precedes a time that a card is drawn. In an embodiment, the bet close time is adjustable based on a decision cycle time, as discussed herein.

In operation, the electronic gaming machines, including blackjack machines 110, utilize one or more random number generators to control various mechanical aspects of the game play, including card draws. The one or more random number generators are used to increase a randomization of events composing the games. Increasing the randomization of events composing the games reduces a likelihood that game cycle results are predictable. For example, random number generators may dictate a card draw, or a timing of various events composing the live blackjack games, and the like.

Central display 120 is configured to present players and other guests of the casino or other gaming establishment with information associated with the live blackjack games operated by the gaming system 100. Such information may be presented in a visual format, an auditory format, or a combination thereof. The information presented by central display 120 may include information regarding individual results of previous game cycles, a state of a current betting window associated with the gaming system 100, statistics about previous games cycles, an operating condition of the gaming system 100, a progressive jackpot associated with gaming system and/or blackjack gaming events, and the like. In an embodiment, central display 120 is further configured to present players and other guests of the casino or other gaming establishment with advertising media.

The display 120 may be interactive touch screen display, which allows a player to make selections and interact with a gaming interface on the display. The gaming interface may include a betting layout indicating a plurality of symbols and types of bets associated with the gaming event. In some examples, the player stations may be arranged around a perimeter of a gaming table.

The one or more player stations may be positioned around the gaming table to allow easy viewing of an event or a result, and to easily place bets at the interactive gaming interface. Various arrangements of player stations may be possible, depending on space, size, and player considerations. In some examples, the one or more player stations may include a Radiofrequency Identification (RFID) reader to allow a player to login to a player account. Various interfaces, including live video feeds (e.g., PIDs), gaming interfaces, and a tournament display interface, may be interchanged on the display associated with a player station.

The one or more player stations may be physically connected and/or wirelessly connected to a dealer console managing aspects of gaming events. At least one computing device may be connected to the dealer console and the one or more player stations to configure, manage, and operate gameplay. A live video feed of the gaming event (e.g., roulette wheels and spins, card dealing, etc.) may be provided on the player display to allow a better view of the gaming events, and to see that the gaming events and results on the interactive interface correspond to the live, physical gaming event at the gaming table.

A gaming unit may include at least one gaming controller to operate the table game. The gaming unit may include software configured to at least provide and manage the dealer interface, player interface(s), a timing of gameplay actions, a result determination, and a wager resolution. The gaming unit may include multiple computing devices, such as a first computing device to operate and manage gaming aspects related to the first roulette and a second computing device to operate and manage gaming aspects related to the second roulette wheel.

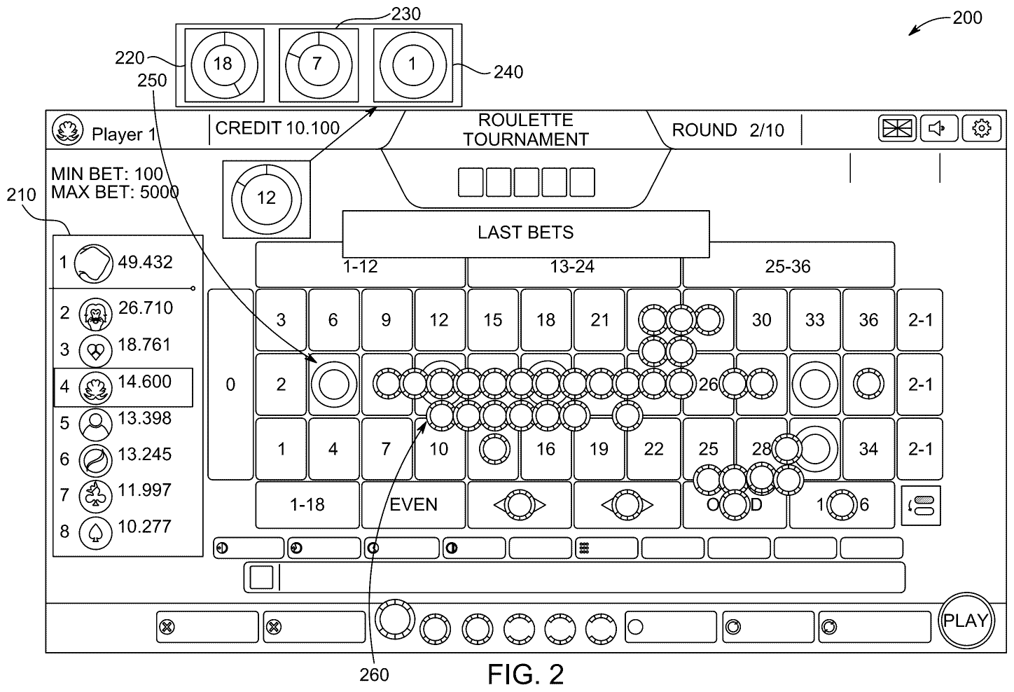

FIG. 2 illustrates an example tournament gaming interface 200 for a roulette gaming event. The gaming interface 200 includes a first betting layout displaying betting options associated with a roulette wheel. The betting layout may correspond to available symbols (e.g., numbers, colors, etc.) and betting options provided on the respective roulette wheel. FIG. 2 illustrates an example interface for a single zero roulette wheels, although double zero roulette wheels and betting layouts may be used as well. The gaming interface may be provided on a display associated with a player station or other player device, such as a mobile computing device, tablet, or laptop.

A leaderboard 210 may identify a set of players participating in the tournament and their ranking. The leaderboard may, for example, identify one or more bets associated with the player (e.g., a current bet, last bet, etc.), and a total number of points or money associated with the player. The leaderboard 210 may be automatically updated in real time as rounds occur and bets are placed.

Betting indicators 220, 230, 240 may provide information regarding whether a betting window is open or closed, and to help a player to quickly determine where and when to place bets. A first indicator 220 may be provided in a first color (e.g., green) to indicate that a betting window is open. The indicator 220 may also provide text (e.g., “Place Your Bets”) and a time left in the open betting window. A second indicator 230 may be provided in a second color (e.g., yellow) to indicate that a betting window is closing soon. The indicator 230 may also provide text (e.g., “Last Bets”) and the time left in the open betting window. A third indicator 640 may be provided in a third color (e.g., red) to indicate that betting window has minimal time left and/or that a betting window is closed. The indicator 240 may also provide text (e.g., “Last Bets” or “No More Bets”), any time left in the betting window, or a time until a new betting window is opened. A Win Amount (e.g., $10.00) may be displayed on the interface following a gaming event. The Win Amount may be displayed using one or more colors and animations on the display.

A set of symbols, such as “Lucky Numbers,” may identify one or more symbols associated with a multiplier. These special symbols may be identified on the betting layout, as seen by the Lucky coin 250, placed on the numbers 5, 11, 17, 31, and 32, associated with the Lucky Numbers. As the Lucky Numbers on the layout may be covered by the Lucky coin 250, the Lucky Numbers may also be displayed at the top of the display between “Roulette Tournament” and “Last Bets.” As discussed herein, the gaming interface supports single zero roulette games and double zero roulette games depending on the type of wheel used for the automated roulette wheel.

A player may place chips 260 on the betting layout to indicate where they would like to place a bet. A chip value may be selected and changed to allow various bet amounts to be placed. In some examples, the gaming interface 210 allows easy bet placement. Players can drag a finger, pointer, or other indicator across the gaming interface to quickly identify the bets they would like to place. Chips will be automatically placed on the path, in real time. As noted above, bets may be placed during the betting window. The betting window will be the same for all players.

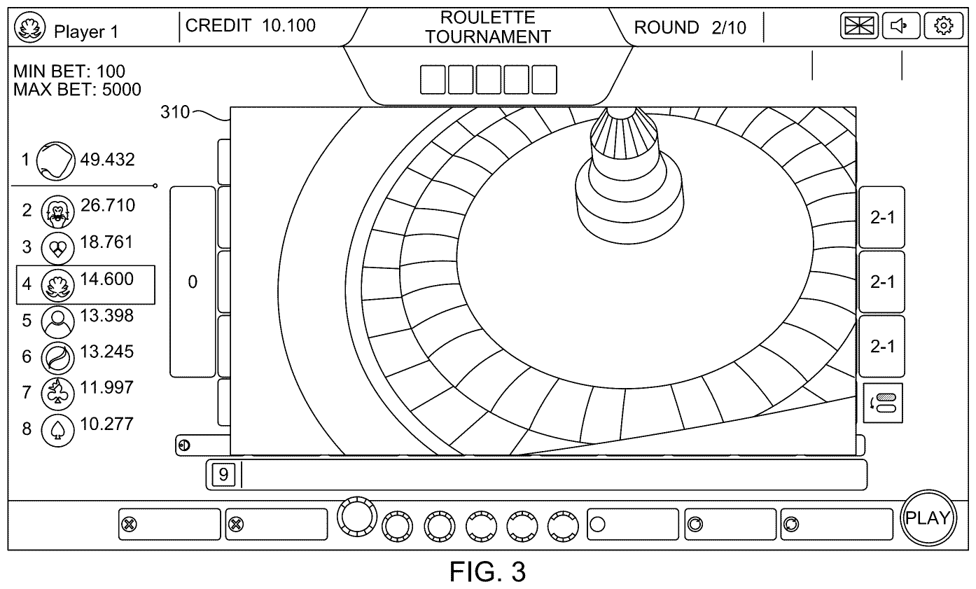

As seen in FIG. 3, the tournament interface may include a PID or a Picture-in-Picture (PIP) live feed 310 of a gaming event. In a PID, the live video feed may fill an entire display. In a PIP, the live video feed may be provided within a portion of a display, such as on a gaming interface and/or overlaid on another image on the display. In some embodiments, at least one computing device provides, in real time, a live feed of a roulette event at the roulette wheel to the one or more player stations. The player station displays may therefore include a Picture-in-Picture (PIP) or Picture-in-Display (PID) overlay of the automated roulette wheel on a betting layout.

In FIG. 3, the live feed 310 shows a real time, live video feed of a roulette event. The live feed 310 may be shown, enlarged, or otherwise displayed after bets have been accepted, and the gaming event (e.g., roulette wheel spin and ball launch) is set to begin. The live feed 310 allows a player to watch an event live, in real-time, and experience the event similar to how the player would see the event live. For a roulette event, the live video feed may show a start of the wheel spin, a roulette ball launch, and a gaming event result, such as when the roulette ball falls into a pocket. The PIP display may be enlarged, minimized, moved and locked to a desired position. In some examples, the player is located at or near a table where the gaming event is occurring. The live feed 310 may provide an additional view of the gaming event and allows the player to verify for themselves that the event happening on the screen is also occurring in real life.

A PIP controller may manage aspects of the one or more visual displays used with roulette gaming table. The PIP controller may include software configured to arrange one or more of images and videos on a player interface and the dealer interface(s). For example, the PIP controller may manage one or more aspects related to video size, position, and resolution on displays. A live video feed, for example, may be provided on a gaming interface, such as overlaid on a betting layout provided on a display on a player station. In some examples, the PIP controller may manage image and video display and placement related to one or more games, jackpots, and tournaments playable with the roulette gaming table. The PIP controller may be wired or wirelessly connected to other electronics components housed within the gaming cabinet. In some examples, the PIP controller is housed external to the gaming cabinet and communicates with one or more displays and player stations wirelessly.

A PID controller may similarly manage aspects of the one or more visual displays used with the roulette gaming table. A PID controller may provide a picture or video within a display. The PID controller may modify picture or video sizing, resolution, position, and other visual characteristics to fit on displays of various sizes. In an example, the PID controller may include software to operate a Tournament game. The Tournament display may provide a unique interface for player devices, through which players may compete against each other during gaming events, such as one or more roulette gaming events. The PID controller may provide additional visual and/or interactive features to connected displays, such as alternate gaming events, advertisements, and information.

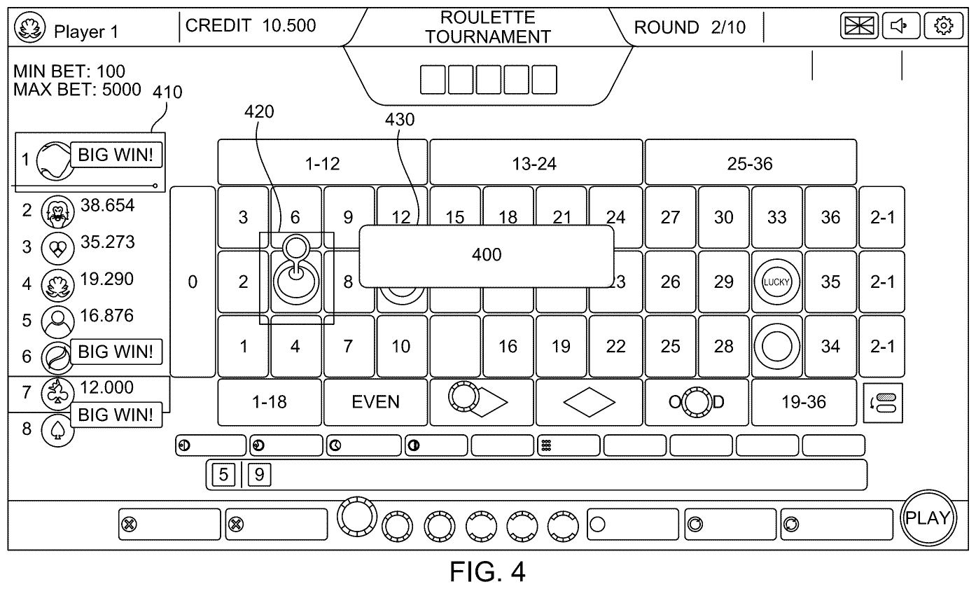

FIG. 4 illustrates a gaming interface during a payout. The leaderboard may identify players having a Big Win 410 and indicate the amount of money won. A dolly 420 may be placed on the betting layout when a winning number corresponds with a special number, such as the Lucky Number. In FIG. 4, a win occurred on Lucky Number 5, and the dolly 420 identifies the win on the Lucky Number. A total payout for the round 430 may be provided on the interface in a prominent position, such as the center of the screen.

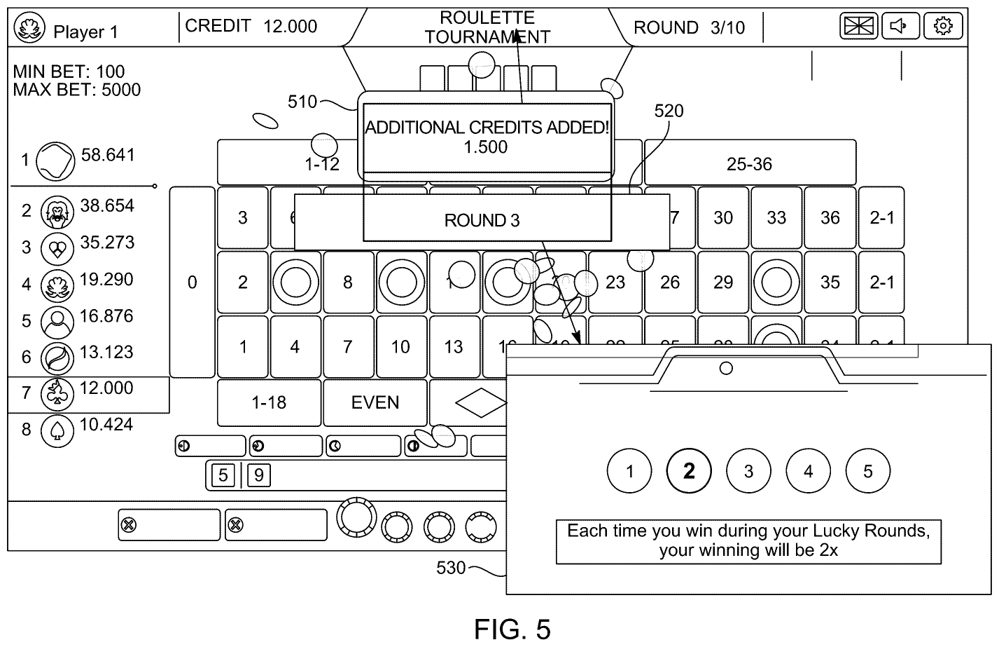

FIG. 5 illustrates an example interface during a start of a new round during a tournament. When a current player adds credit, a notification 510 may prominently appear to confirm receipt of credits. The new round notification 520 may be prominent displayed as well.

The cutout 530 shows an example tournament feature, wherein a player may be provided an option to select one or more rounds as “Lucky Rounds” to increase winnings. In the example, Round 2 has been selected as a Lucky Round, and any wins during Round 2 will be doubled. Since tournaments are fully configurable a number of Lucky Rounds and other special game or round multipliers may be applied at the discretion of the tournament manager and set at the dealer console. Other types of special gaming multipliers may be available.

The gaming interfaces, as illustrated in FIGS. 2-5, may include additional gameplay features, options, and modifications to enhance player experience, and enable a player to customize their gaming experience. For example, a top bar of the player interface may provide a summary regarding the current game and one or more quick-action selections. The top bar may indicate credits, including a “Credit” box indicating a total number of credits, e.g., related to a player account, and a “Playable” box indicating an amount of credits that the player can bet. A “Cash Out” button enables a player to cash out and receive any player credits via ticket printer, a credit add to a player account, or a cash pay out from a dealer. The Cash Out selection may only be available when no bets are currently on the table.

Configurable selections may be provided to enable a player to customize a view of the player interface. For example, an opacity button may be provided to enable a player to reduce the visibility of the player's credits, last bet(s), and the playable amount. A “Main Information” display may provide gaming information, such as when a betting window opens, a time left in the betting window, and when a betting window closes. Error messages may also be provided. A “Call Attendant” or “Concierge” button may signal an attendant of the gaming device, an attendant on the casino floor, or another individual associated with the gaming location and assisting players. A “Flag” button may indicate a language used on the interface, and a selection of the button may enable a player to change the interface language. An “Options” button may bring up a menu that includes additional information about the gameplay or the device. In some examples, the Options menu may include “Show Winnings,” which will display, as the user places bets, possible winnings for each bet. The possible winnings may be enabled or disabled using a slider or other toggle button. A “Number Orientation” option will allow a player to set a desired number orientation on the roulette table view to be vertical or horizontal. A “Show Bet Limits” option will change a display of the roulette table to a display of bet limits for different wagering options. A “Reserve Table” option allows players to reserve a player station for a period of time. A “Help/Rules” option displays a help screen.

Betting information may be provided for the gaming event. The betting information may indicate a Bet, Last Win, and Last Bet information. A Display Adjustment button allows a player to adjust their gaming layout. A history bar may display the last pre-set number of wins corresponding to the roulette wheel.

A betting table may provide a betting layout including betting fields arranged similarly to a live table. The betting table may include betting options and combinations. Players may choose one or more selections to assign a bet.

A bet timer may provide an indication of whether a betting window is open or closed and may provide a time left for a player to place a bet. A Statistics button may be provided on each betting layout to see respective gaming statistics for each roulette wheel.

A “Special Bets” button may be provided on each betting layout to bring up additional betting combinations. In roulette, for example, such betting combinations may include but are not limited to Single Zero, Double Zero, Triple Zero, Neighbors of (Big) Zero, Small Series, Orphans, Final, Complete, Red Snake, Red Splits, Black Splits, and Neighbors.

Controls may enable Denomination, Chips, and Game Controls for each respective layout. A Denomination control sets the value of one credit and hence the value of the game. The selected value of one credit may be displayed on the denomination button. The Chips control enables players to select and place chips of different values on the table. Values assigned to chips may be defined with the selected denomination. In some examples, if multi-denomination is disabled, only chips may be available. The Game Control selection may include features to Clear Last Bet, Clear All Bets, Double Bet, Repeat Last Bet, Game Chips, and Fast Bet (i.e., selecting multiple options by dragging a finger across desired fields).

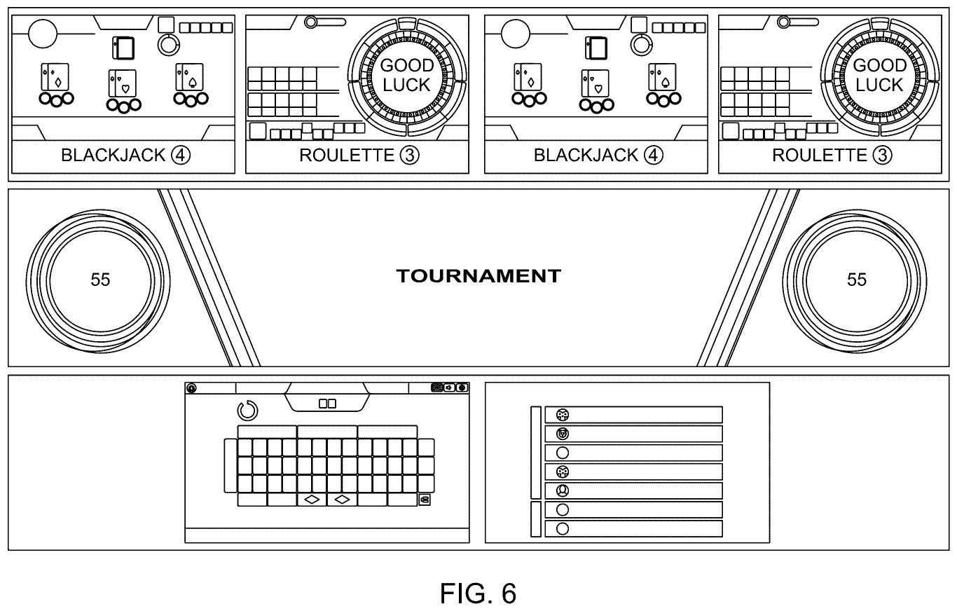

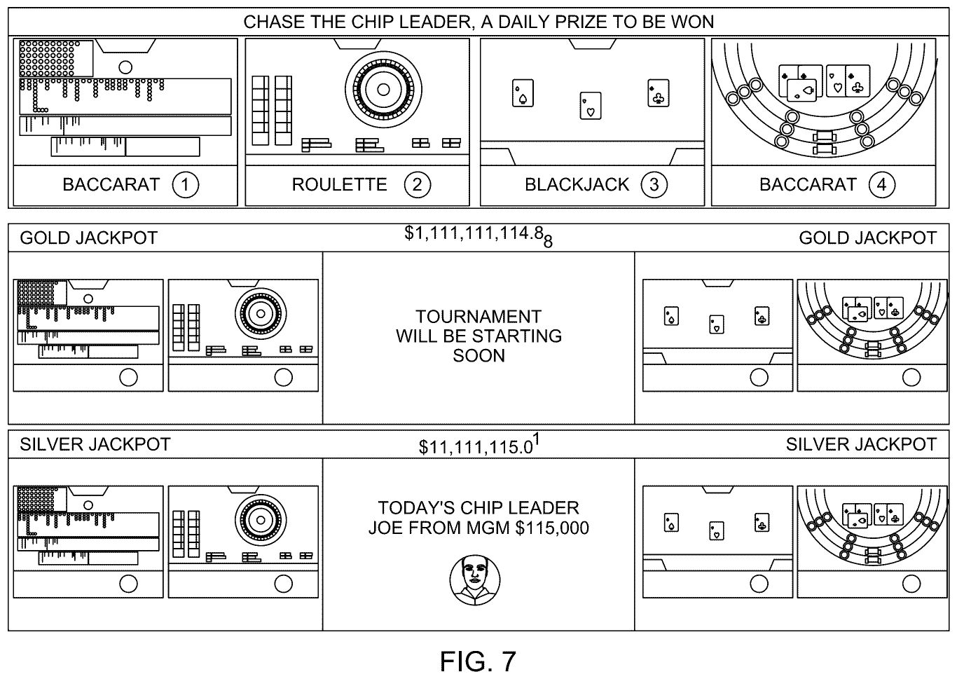

FIGS. 6-7 illustrate example display banners, popups, and tickers that may be provided on gaming interfaces to inform a player about tournament information. Tournament information may be provided gaming interfaces on one or more player stations and displays to keep players apprised, for example, of current standings, upcoming tournaments, a current leaderboard, and prizes that may be won by playing tournament events.

FIG. 6 illustrates banners that may occur on a player station or player device. A first banner may identify tournament games currently available to join. When a game is selected, one or more countdown timers may appear (on the left and right of the screen) to indicate the time left before the game begins. When the countdown expires, a betting layout and/or a leaderboard may be provided. Other views, layouts, animations, sounds, effects, colors, pictures, videos, and displays may be provided to attract players to join tournament events.

FIG. 7 illustrates additional examples of banners that may be provided on a player station or display. A ticker may run across a Picture-in-Display on a player station may state tournament information, such as “Roulette & Blackjack Tournaments Running Throughout G2E”, “Chase the Chip Leader, A Daily Prize to Be Won,” and “Today's Chip Leader is Joe $115,000.” In some examples, two or more messages may alternate. For example, “Tournament Starting Soon” may alternate with “Today's Chip Leader is . . . ” These informational displays may be a banner on a top portion of the gaming interface, a window that pops up, or other distinctive text, animation, sound, or effect to inform a player about tournament information. In some examples a dealer console may manage aspects of tournament information and how they are provided to and displayed at one or more player devices and gaming interfaces.

In an example, configurable aspects of Tournament events may include a type of game, (e.g., single zero roulette, double zero roulette, single hand blackjack, multihand blackjack, baccarat), a number of rounds (e.g., 1 to N), a starting credit minimum (e.g., 30 credits), a minimum bet (e.g., 100 credits), a max bet (e.g., 500 credits, a bet timer indicating a time open for bets (e.g., 20 seconds), a decision timer (e.g., 5, 6, 7, 8 seconds), included side bets where applicable, and a connection type (video, live generator, automated generator, etc.). Other types of variables and gaming features may be included depending on a type of game.

In a “First Come First Serve” Tournament mode, players are able to enter the tournaments on “first come first serve” basis. A Tournament host may schedule the tournament but does not assign the number of terminals only for tournament. In some examples, the Tournament happens once, and there are no multi rounds. Configurable aspects may include: tournament name (e.g., “Monday's Roulette Tournament”), a schedule (e.g., Mondays at 6 pm), and a game type (e.g., single event, reoccurring event type). In some examples, “First Come First Serve” Tournament Game profile may be preselected as a default type of Tournament. Additionally, more than one Tournament game profile can be selected for a Tournaments Schedule, and advertisements provided on a PID and GUI. The timing and frequency of Tournament advertising notifications may also be adjusted, e.g., every 2 hours, 1 hour, 30 minutes, 15 minutes, 5 minutes, or another custom value.

Player stations may be reserved for tournament gameplay. When tournaments begin, a Tournament host (e.g., a dealer) may review tournament details at a dealer console. The dealer console may identify one or more player stations to be associated with the tournament event, and a notification may be provided at the one or more player stations to let any players at those stations know that a tournament game is coming up, and to cash out of a current game to play in the tournament event. In some examples, tournament hosts may, at the dealer console, assign player stations without current credits and players to be usable with the tournament. After any current players at the tournament player stations have cashed out or joined the tournament event, the tournament gameplay may begin.

Tournament hosts may manage aspects of the PID on player devices. The PID may be displayed along with a leaderboard. Both may be updated in real time. When the tournament event has finished, a player may receive a ticket indicating a player identification, a final position in the tournament, and the tournament game name. Prizes and rewards may e awarded based on the printed ticket information.

In a “Scheduled Registrational Tournament,” players may register via a kiosk and receive a unique PIN code via email and/or a printed ticket. The Tournament host may direct customers to designated player stations in the tournament mode, and players are prompted to enter the unique PIN. Similar to other tournament events discussed herein, the PID may display a leaderboard and a time remaining until the end of the tournament event. Players may view their current position in an upper portion of the screen, and a leaderboard may be provided as well. At the end of the tournament event, the top winners may be publicly announced.

In an example Scheduled Registrational Tournament, a game name may be defined (e.g., “Wednesday's Big Roulette Tournament”). The tournament may be set as a single event or as a reoccurring event (e.g., every Wednesday at 4 pm). The type of tournament may be selected, along with configurable options for the one or more rounds of the tournament. For example, Quarterfinals may be set at a first date and time, Semifinals may be set at a second date and time, and Finals may be set at a third date and time. Advancement rules for each round may also be defined. For example, a top 3 players qualify for the next round, or players having a minimum score qualify for the next round. Scores may or may not carry over from a previous game to a next game. A game profile may be associated with a selected tournament. Advertisement and banner scheduling may be configured, as well as a number of player stations assigned to the tournament.

For each type of tournament gaming event, a tournament report and game history may be viewable at the dealer console. Such information may be usable for audit and dispute resolution, and may be exported to a remote computing device as a CSV file or HTML.

In a “Cross Property” or “Wide Area” Tournament, instructions at a dealer console may schedule tournaments associated with one or more locations. For example, a casino having four different properties may host and manage a tournament event that has players from each property. The dealer console may be configured to select one or more locations from which to accept players. A location name and avatar may be provided. Players may register in multiple locations and decide on which location to compete. Gameplay may then occur as described herein.

In an “Automated Tournament,” a tournament may occur without the need for additional hosts and controls to be defined and managed at the dealer console. Automated Tournaments may include “First Come First Served” and “Schedule Registrational” Tournaments. In an example with player stations within a stadium or arena, all players may receive a notification (e.g., banner, pop up, ticker, etc.) that there is a scheduled tournament in time intervals defined on the dealer console. Players will be given an option to cash out of their current came and join the tournament event. Tournament events may occur as described above, but without a tournament host starting the tournaments. Player stations associated with the automated tournament event may automatically switch to tournament mode and join the tournament event. Additional help and instructions for a player on how to join the tournament may be displayed via a PID, ticker, or other text/notification.

In an “Individual Tournament,” a single tournament round may be played. This may serve as an educational tool for new tournament players. Players would have an ability to do this on a multi-game player station, and may play any available tournament game. In some examples, a tournament host, attendant, or other supervisor may need to provide permissions to play the “Individual Tournament” and tournament characteristics may be configured as well.

In a “Buy-In Tournament,” players may compete for a cash prize. The cash prize may be an accumulation of all player fees.

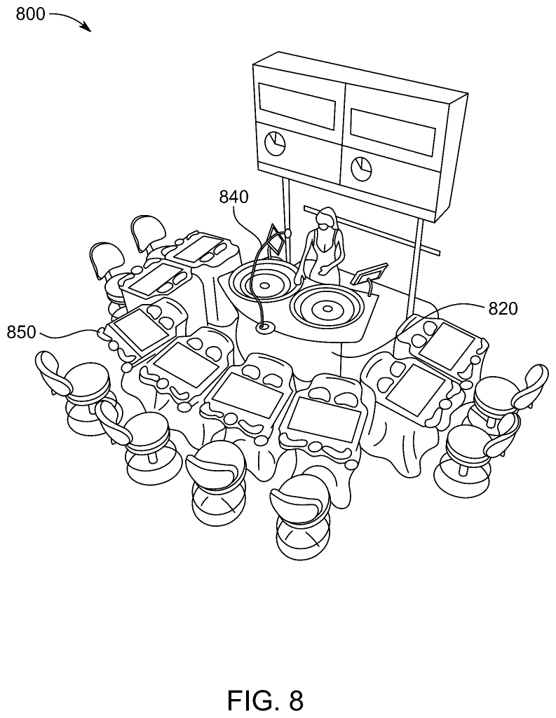

FIGS. 8-10 illustrate additional examples of gaming systems and arrangements on which the tournament gameplay and features may operate. In various examples, the dealer console may initiate a “Tournament Mode” to start one or more tournament events, tournament gaming interfaces, and game flows, as discussed herein. The “Tournament Mode” may be toggled on and off to switch between regular table games, a hybrid table game, and the tournament gameplay. In some examples, the tournament gameplay may occur with a hybrid or dealer-assisted gaming event.

FIG. 8 provides an illustration of the live ETG roulette game 800. The roulette game 800 includes two roulette wheels 810 with their own random number generators 820 underneath (or remotely located), a display 830 for displaying the results for both roulette wheels 810 a single dealer with a dealer console 840, and a plurality of player consoles 850. The display 830 is divided between the two roulette wheels 810, one side one color and one side a different color so players can readily tell them apart. Synchronization between the two roulette wheels 810 may be controlled by the dealer console 840 or automatically controller by the random number generators 820. The dual roulette wheels 810, combined with the player consoles 850 automatically settling bets in place of the dealer, results in three to four times more game results per hour with virtually zero payout errors. The fact that one dealer can deal more live roulette to any number of players greatly increases revenue, while the increase in player to dealer ratio, eliminating 1-2 full-time equivalent (FTE) employees, and reducing the compensation cost associated with only needing less skilled dealers, greatly enhances profitability.

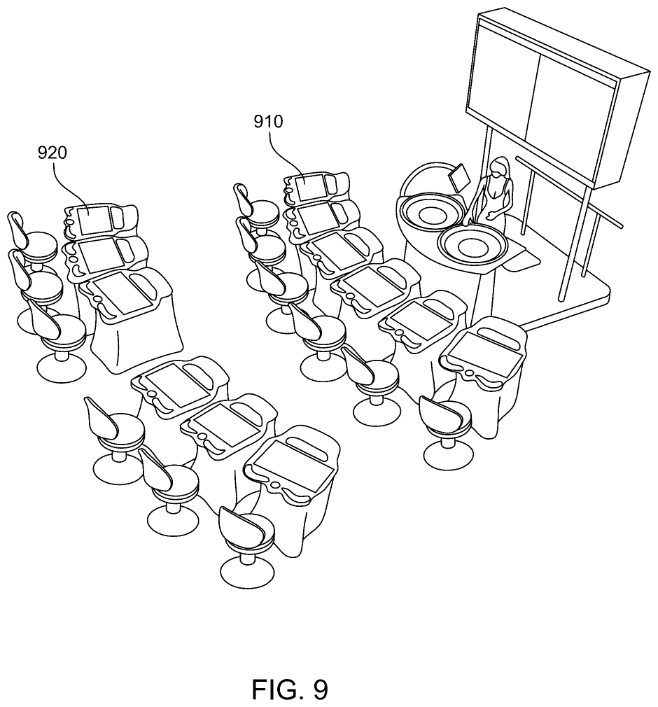

FIG. 9 illustrates an example arrangement of the ETG roulette game within a stadium environment, which may include a live arena, or casino pit. In various examples, up to 240 stations can be connected to the roulette game. In some examples, as illustrated in FIG. 9, the player stations may be arranged around the roulette gaming table in an arena or stadium on a casino floor. In various embodiments, the one or more player stations are arranged in one or more rows 910, 920 extending outwardly from the roulette gaming table. Player stations may be grouped together (e.g., two, three, or more) to allow groups of players to play near each other. Individual player stations may also be provided for solo play within the stadium environment. The one or more player stations may be positioned to face the roulette gaming table, so as to allow viewing of a display, the dealer, and/or the physical roulette wheels at the roulette gaming table. The roulette gaming table may be on a raised platform, or otherwise have its height position adjusted to accommodate the particular characteristics of the room. Some stadium arrangements, for example, may include a pit area. The pit area may slope downwards towards the roulette gaming table, such that the one or more player stations are at a higher height than the roulette gaming table and can better view the physical roulette wheels.

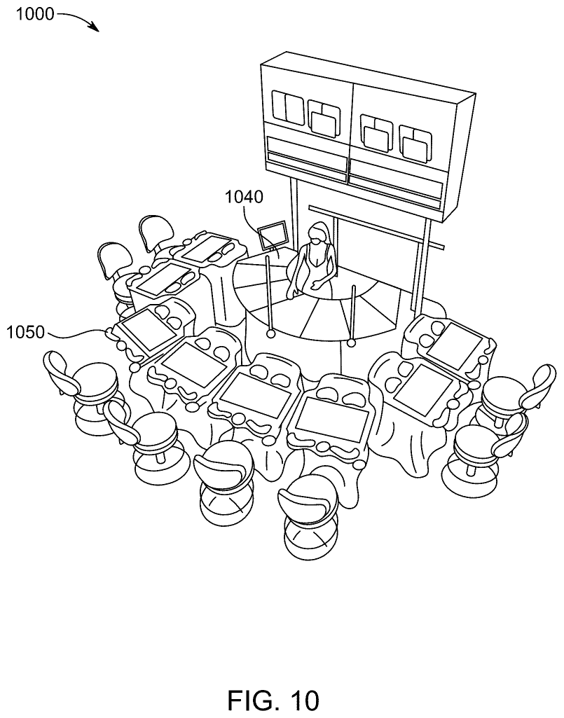

FIG. 10 provides an illustration of the live, hybrid ETG card game 1000 with dealer assist. The hybrid ETG card game 1000 includes a card gaming table with two gaming areas 1010, a card shoe, a display 1030 for displaying the results for both card gaming areas 1010, a single dealer with a dealer console, and a plurality of player consoles 1050. The display 1030 is divided between the two card gaming areas, one side one color and one side a different color so players can readily tell them apart. Gaming events at each card gaming area 1010 may be controlled by the dealer console. The dual card gaming areas, combined with the player consoles 1050 automatically settling bets in place of the dealer, results in three to four times more game results per hour with virtually zero payout errors. The fact that one dealer can deal more live card to any number of players greatly increases revenue, while the increase in player to dealer ratio, eliminating 1-2 full-time equivalent (FTE) employees, and reducing the compensation cost associated with only needing less skilled dealers, greatly enhances profitability.

In an example, a live ETG baccarat game can be played using the hybrid ETG card game 1000. The baccarat game may include two card shoes for two different hands of baccarat, a display for displaying the results for both card shoes, a single dealer with a dealer console, and a plurality of player consoles. The single dealer can deal the two shoes sequentially, resulting in more hands and more income per hour. The shoes may be shuffled by the dealer, an auto shuffler, or be served by a random generator shoe. The baccarat game options include traditional 5% commission, or no-commission baccarat with a variety of side bets through the graphical user interface of the player consoles, such as lucky nines, any pair, Hi-Ti and super 6. The dual shoes, combined with the player consoles automatically settling bets in place of the dealer, results in more game results per hour with virtually zero payout errors. The fact that one dealer can deal up to two times more live baccarat to any number of players greatly increases revenue, while the increase in player to dealer ratio, eliminating 1-2 full-time equivalent (FTE) employees, and reducing the compensation cost associated with only needing less skilled dealers, greatly enhances profitability.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

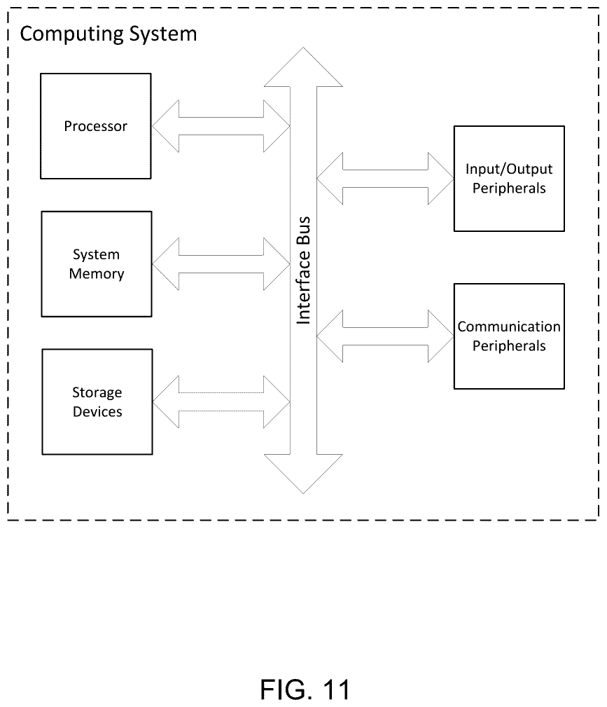

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 11 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the roulette wheel velocity adjustments and result detection optimization, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a live tournament gaming system, comprising: a plurality of player stations comprising a display and providing a gaming interface to enable a player to wager on a gaming event, wherein the gaming event is a table game providing virtual play; a dealer console configured to enable a dealer to operate the gaming event, the dealer comprising a processor and a memory, the memory comprising instructions, which when executed by the processor, cause the computing device to: configure gameplay variables for a tournament event, wherein the gameplay variables comprise a number of rounds, a chip minimum; register a subset of the player stations for the tournament event based on a request from the player station; provide a tournament interface on each display associated with the subset of player stations, wherein the tournament interface is configured to receive a bet during a betting window for each round of the tournament event; and after each round, determine a payout associated with each player station, and update, in real time, a leaderboard on the tournament interface.

In an embodiment, wherein the dealer console is further configured to provide, prior to a start of the tournament event, a notification identifying one or more tournament events available to join.

In an embodiment, wherein the notification comprises at least one of text, an animation, an image, a sound, and a video.

In an embodiment, wherein the notification identifies a current leader associated with a set of tournament events.

In an embodiment, wherein the dealer console is further configured to provide a live video feed of the gaming event on the tournament interface.

In an embodiment, wherein the table game is blackjack, baccarat, or roulette.

In an embodiment, wherein the betting window is between 15 and 25 seconds, the number of rounds is three, and the tournament event is less than seven minutes.

In an embodiment, wherein the dealer console is further configured to provide, at each player station in the subset of player stations, an animation identifying an outcome of each round of the tournament event, and a payout.

In an embodiment, a non-transitory computer readable medium comprising instructions stored thereon, which when executed by a processor, cause a computing device to: configure gameplay variables for a tournament event, wherein the gameplay variables comprise a number of rounds, a chip minimum; register one or more player stations for the tournament event; at a first player station, provide a tournament interface configured to receive a bet during a time-limited betting window for each round of the tournament event; and after each round, determine a payout associated with each player station, and update, in real time, a leaderboard on the tournament interface.

In an embodiment, wherein the gaming event is roulette, and further comprising instructions to display a live feed of an automated roulette wheel on the gaming interface, and display an animation to indicate a set of symbols and multiplier values on the betting layout.

In an embodiment, wherein the gaming event is a card game, and further comprising instructions to display, on the gaming interface, a live feed of cards being dealt, and define a time limit to receive a gaming decision for each hand dealt.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A live tournament gaming system, comprising:
a plurality of player stations comprising a display and providing a gaming interface to enable a player to wager on a gaming event, wherein the gaming event is a table game providing virtual play;
a dealer console configured to enable a dealer to operate the gaming event, the dealer comprising a processor and a memory, the memory comprising instructions, which when executed by the processor, cause the computing device to:
configure gameplay variables for a tournament event, wherein the gameplay variables comprise a number of rounds, a chip minimum;
register a subset of the player stations for the tournament event based on a request from the player station;
provide a tournament interface on each display associated with the subset of player stations, wherein the tournament interface is configured to receive a bet during a betting window for each round of the tournament event; and
after each round, determine a payout associated with each player station, and update, in real time, a leaderboard on the tournament interface.

2. The live tournament gaming system of claim 1, wherein the dealer console is further configured to provide, prior to a start of the tournament event, a notification identifying one or more tournament events available to join.

3. The live tournament gaming system of claim 2, wherein the notification comprises at least one of text, an animation, an image, a sound, and a video.

4. The live tournament gaming system of claim 2, wherein the notification identifies a current leader associated with a set of tournament events.

5. The live tournament gaming system of claim 1, wherein the dealer console is further configured to provide a live video feed of the gaming event on the tournament interface.

6. The live tournament gaming system of claim 1, wherein the table game is blackjack, baccarat, or roulette.

7. The live tournament gaming system of claim 1, wherein the betting window is between 15 and 25 seconds, the number of rounds is three, and the tournament event is less than seven minutes.

8. The live tournament gaming system of claim 1, wherein the dealer console is further configured to provide, at each player station in the subset of player stations, an animation identifying an outcome of each round of the tournament event, and a payout.

9. A non-transitory computer readable medium comprising instructions stored thereon, which when executed by a processor, cause a computing device to:
configure gameplay variables for a tournament event, wherein the gameplay variables comprise a number of rounds, a chip minimum;
register one or more player stations for the tournament event;
at a first player station, provide a tournament interface configured to receive a bet during a time-limited betting window for each round of the tournament event; and
after each round, determine a payout associated with each player station, and update, in real time, a leaderboard on the tournament interface.

10. The non-transitory computer readable medium of claim 9, wherein the gaming event is roulette, and further comprising instructions to display a live feed of an automated roulette wheel on the gaming interface, and display an animation to indicate a set of symbols and multiplier values on the betting layout.

11. The non-transitory computer readable medium of claim 9, wherein the gaming event is a card game, and further comprising instructions to display, on the gaming interface, a live feed of cards being dealt, and define a time limit to receive a gaming decision for each hand dealt.
